(19) United States
(12) Patent Application Publication
(10) Pub. No.: US 2016/0076591 A1
(43) Pub. Date: Mar. 17, 2016

(54) BEARING COMPONENT

(71) Applicants: AKTIEBOLAGET SKF, Göteborg (SE); SKF AEROSPACE FRANCE, Saint-Vallier-sur-Rhône (FR)

(72) Inventors: John BESWICK, Montfoort (NL); Mobamed SHERIFF, Hilversum (NL); Gauthier BEAURlN, Lyon (FR)

(73) Assignee: Aktiebolaget SKF, Göteborg (SE)

(21) Appl. No.: 14/891,447

(22) PCT Filed: May 16, 2014
(86) PCT No.: PCT/EP2014/060058

§ 371 Date: Nov. 16, 2015

(30) Foreign Application Priority Data
May 21, 2013 (EP) 13168522.4

(51) Int. Cl. F16C 33/62; F16C 33/32; F16C 33/34; C22C 38/02; C22C 38/22; C22C 38/04; C22C 38/00; C22C 38/30; C22C 38/24

(52) U.S. Cl. CPC F16C 33/62; C22C 38/30; F16C 33/32; F16C 33/34; C22C 38/24; C22C 38/22; C22C 38/04; C22C 38/002; C22C 38/02

(57) ABSTRACT

A bearing component formed of a steel comprising: (A) from 0.8 to 2.5 wt. % C, (B) from 3.5 to 4.5 wt. % Cr, (C) from 3.9 to 11.25 wt. % Mo, (D) optionally one or more of the following elements: (D1) from 0 to 8.2 wt. % W, (D2) from 0 to 11 wt. % Co, (D3) from 0 to 0.5 wt. % Ni, (D4) from 0 to 6.75 wt. % V, (D5) from 0 to 0.35 wt. % Si, (D6) from 0 to 0.4 wt. % Mn, (D7) from 0 to 0.3 wt. % S, and (D8) from 0 to 0.05 wt. % P, and (E) the balance iron, together with unavoidable impurities.

### CROSS REFERENCE TO RELATED APPLICATIONS

This is a United States National Stage Application claiming the benefit of International Application Number PCT/EP2014/060058 filed on 16 May 2014 (16.05.2014), which claims the benefit of Europe (EP) Patent Application 13168522.4 filed on 21 May 2013 (21.05.2013), both of which are incorporated herein by reference in their entireties.

### TECHNICAL FIELD

The present invention relates to the field of steels and bearings. More specifically, the present invention relates to a novel bearing component, a method of forming a bearing component and a bearing comprising such a component.

### BACKGROUND OF THE INVENTION

Bearings are devices that permit constrained relative motion between two parts. Rolling element bearings comprise inner and outer raceways and a plurality of rolling elements (balls or rollers) disposed therebetween. For long-term reliability and performance it is important that the various elements have a high resistance to rolling contact fatigue, wear and creep.

Ceramic rolling elements have been considered for use in bearing applications, including highly loaded main shaft aero engines. There are, however, perceived intrinsic limitations associated with the use of ceramic materials in safety critical applications. Powder metallurgy (PM) high speed steels (HSS) offer an alternative for specific, very highly loaded, high temperature aero engine requirements.

The high speed steel M50 comprises from 0.77 to 0.85 wt. % C, up to 0.35 wt. % Mn, up to 0.25 wt. % Si, from 3.75 to 4.25 wt. % Cr, up to 0.15 wt. % Ni, from 4.00 to 4.50 wt. % Mo, 0.90 to 1.10 wt. % V, up to 0.10 wt. % Cu and a balance of Fe and unavoidable impurities. The high speed steel T1(18-4-1) comprises from 0.65 to 0.80 wt. % C, up to 0.40 wt. % Mn, up to 0.40 wt. % Si, 3.75 to 4.50 wt. % Cr, 0.90 to 1.30 wt. % V, 17.25 to 18.75 wt. % W and a balance of Fe and unavoidable impurities. Rolling elements formed of the high speed steels M50 and T1 (18-4-1) have been employed in high temperature aero engines. Such rolling elements may be produced by re-melting and solidification techniques such as, for example, vacuum induction melting (VIM) and vacuum arc refining (VAR). The high speed production processes can produce segregated microstructures with large carbides which can melt during the hot rolling process, forming micro-porosity. The hot working results in anisotropic properties and weak areas in the ball pole region after production by hot forging (see Zaretsky, E. V., “Selection of Rolling-Element Bearing Steels for Long-Life Applications”, Effect of Steel Manufacturing Processes on the Quality of Bearing Steels, ASTM STP 987, J. J. C. Hoo ed., American Society for Testing and Materials, Philadelphia, 1988 pp. 5-43).

It is an objective of the present invention to address or at least mitigate some of the problems associated with prior art and to provide a bearing component that exhibits at least one of high abrasive wear resistance, high local toughness, and resistance to crack growth at elevated temperatures.

### SUMMARY OF THE INVENTION

In a first aspect, the present invention provides a bearing component formed of a steel alloy comprising:

(a) from 0.8 to 2.5 wt. % C,

(b) from 3.5 to 4.5 wt. % Cr,

(c) from 3.9 to 11.25 wt. % Mo,

(d) optionally one or more of the following elements
from 0 to 8.2 wt. % W,
from 0 to 11 wt. % Co,
from 0 to 0.50 wt. % Ni,
from 0 to 6.75 wt. % V,
from 0 to 0.35 wt. % Si,
from 0 to 0.4 wt. % Mn,
from 0 to 0.3 wt. % S,
from 0 to 0.05 wt. % P, and

(e) the balance iron, together with unavoidable impurities.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The steel of the bearing component typically exhibits a fine carbide structure. Accordingly, the bearing component may exhibit isotropic mechanical properties after hot working. Furthermore, the steel may exhibit high strength, high hardness and high resistance to rolling contact fatigue (RCF) at elevated temperatures. Such mechanical properties may render the bearing particularly effective at operating in a high load, high temperature environment such as, for example, an aero engine.

The steel of the bearing component comprises from 0.8 to 2.5 wt. % C, preferably from 1 to 2.4 wt. % C, more preferably from 2 to 2.4 wt. % C, even more preferably from 2.25 to 2.35 wt. % C, and still even more preferably about 2.3 wt. % C. In combination with the other alloying elements, this results in the desired microstructure and mechanical properties, particularly hardness.

The steel of the bearing component comprises 3.5 to 4.5 wt. % Cr, preferably from 3.6 to 4.3 wt. % Cr, more preferably from 3.8 to 4.2 wt. % Cr, even more preferably about 4 wt. % Cr. Chromium acts to increase hardenability. Chromium also provides an improved corrosion resistance property to the steel.

The steel of the bearing component comprises from 3.9 to 11.25 wt. % Mo, preferably from 5 to 11 wt. % Mo, more preferably from 6 to 8 wt. % Mo. Molybdenum acts to avoid austenite grain boundary embrittlement owing to impurities such as, for example, phosphorus. Molybdenum also acts to increase hardenability. Molybdenum imparts toughness for heavy service, and provides especially heat-resistant alloys.

The steel of the bearing component optionally comprises from 0 to 8.2 wt. % W. When the steel comprises W, preferably the steel comprises from 5 to 7.5 wt. % W, more preferably from 6 to 7 wt. % W, even more preferably from 6.3 to 6.7 wt. % W. In combination with the other alloying elements and C, this results in the desired microstructure and mechanical properties, particularly hardness.

The steel of the bearing component optionally comprises from 0 to 11 wt. % Co. When the steel comprises Co, preferably, the steel comprises from 9 to 11 wt. % Co, more preferably from 10.3 to 10.7 wt. % Co, even more preferably about 10.5 wt. %. Cobalt may serve to increase the heat and wear resistance of the steel. In addition, cobalt may serve to increase the high temperature strength and hardness of the steel. Accordingly, the presence of cobalt in the steel may render the bearing particularly suitable for use in a high temperature, high load environment such as, for example, an aero engine. The steel of the bearing component optionally comprises from 0 to 0.5 wt. % Ni.

In a preferred embodiment, the steel of the bearing component comprises both W (up to 8.2 wt. %) and Co (up to 11 wt. %). For example, the steel comprises from 5 to 8.2 wt. % W and from 9 to 11 wt. % Co.

The steel of the bearing component optionally comprises from 0 to 6.75 wt. % V. When the steel comprises V, preferably the steel comprises from 0.75 to 6.75 V, more preferably from 6 to 6.7 wt. % V, even more preferably from 6.3 to 6.7 wt. % V, still even more preferably about 6.5 wt. %. In combination with the other alloying elements and C, this results in the desired microstructure and mechanical properties, particularly hardness.

The steel of the bearing component optionally comprises from 0 to 0.35 wt. % Si. When the steel comprises Si, preferably the steel comprises from 0.15 to 0.35 wt. % Si, more preferably from 0.2 to 0.3 wt. % Si. Silicon may be added during the steel making process as a deoxidizer. Silicon may also act to increase strength and hardness.

The steel of the bearing component optionally comprises from 0 to 0.4 wt. % Mn. When the steel comprises Mn, preferably the steel comprises from 0.2 to 0.4 wt. % Mn, preferably from 0.3 to 0.4 wt. % Mn. The manganese, in combination with the other alloying elements, may increase hardness and may contribute to the steel's strength. Manganese may also have a beneficial effect on surface quality.

In a preferred embodiment, the steel of the bearing component comprises from 2.2 to 2.4 wt. % C, from 3.8 to 4.2 wt. % Cr, from 6.8 to 7.2 wt. % Mo, from 6.3 to 6.7 wt. % W, from 6.3 to 6.7 wt. % V and from 10.3 to 10.7 wt. % Co. Such a steel exhibits particularly high strength, hardness and resistance to rolling contact fatigue at elevated temperatures. Accordingly, a bearing component formed of such a steel is particularly effective at operating a high load, high temperature environment such as, for example, an aero engine.

In a preferred embodiment, the steel comprises from 1.1 to 1.5 wt. % C, from 3.7 to 3.8 wt. % Cr, from 10 to 11 wt. % Mo, from 0.2 to 0.3 wt. % Si and from 0.3 to 0.4 wt. % Mn. Such a steel exhibits particularly high strength, hardness and resistance to rolling contact fatigue at elevated temperatures. Accordingly, a bearing component formed of such a steel is particularly effective at operating a high load, high temperature environment such as, for example, an aero engine.

It will be appreciated that the steel for use in the bearing component according to the present invention may contain unavoidable impurities although, in total, these are unlikely to exceed 0.5 wt. % of the composition. Preferably, the alloys contain unavoidable impurities in an amount of not more than 0.3 wt. % of the composition, more preferably not more than 0.1 wt. % of the composition. With regard to any phosphorous and sulphur and oxygen, the content of these three elements is preferably kept to a minimum.

The alloys according to the present invention may consist essentially of the recited elements. It will therefore be appreciated that in addition to those elements which are mandatory other non-specified elements may be present in the composition provided that the essential characteristics of the composition are not materially affected by their presence.

The microstructure and resulting mechanical properties lead to improved rolling contact fatigue performance in the bearing component in particular at elevated temperatures.

The bearing component is preferably formed by a powder metallurgical technique. Such a technique may produce a steel with fine carbide structures and negligible weak regions. In addition, such a technique may enable the production of highly alloyed high speed steels with higher hardnesses and strengths after secondary hardening operations. Accordingly, this route is advantageous for high temperature bearing applications. Suitable powder metallurgical techniques include, for example, vacuum induction melting (e.g. by the technique of Crucible Compaction Metals—CPM) or electro slag processes (e.g. the ASEA Stora Process—ASP).

The steel preferably has a strength of at least 65 HRC, preferably at least 68 HRC. The steel preferably has a rolling contact fatigue (RCF) factor at 400° C. of at least 1.5, preferably at least 2. The steel preferably has a hardness (HV5) at 400° C. of at least 700, preferably at least 750. For example, in certain embodiments the bearing component is formed of a PM62 alloy or a ASP2060 alloy exhibiting HV5 values at 400° C. of 703 and 798, respectively. Such mechanical properties may render the bearing particularly effective at operating in a high load, high temperature environment such as, for example, an aero engine.

The bearing component can be at least one of a rolling element (for example ball or roller element), an inner ring, and an outer ring. The bearing component could also be part of a linear bearing such as ball and roller screws.

The bearing component may be an aero engine bearing component. The term aero engine used herein may encompass the component of the propulsion system for an aircraft that generates mechanical power.

In a further aspect the present invention provides an aero engine bearing comprising the bearing component as described herein.

In a further aspect the present invention provides a process for the manufacture of a bearing component, the process comprising:

(i) providing a bearing steel composition comprising:
(a) from 0.8 to 2.5 wt. % C,
(b) from 3.5 to 4.5 wt. % Cr,
(c) from 3.9 to 11.25 wt. % Mo,
(d) optionally one or more of the following elements
   from 0 to 8.2 wt. % W,
   from 0 to 11 wt. % Co,
   from 0 to 0.5 wt. % Ni,
   from 0 to 6.75 wt. % V
   from 0 to 0.35 wt. % Si,
   from 0 to 0.4 wt. % Mn,
   from 0 to 0.3 wt. % S,
   from 0 to 0.05 wt. % P, and
(e) the balance iron, together with unavoidable impurities; and

(ii) forming a bearing component from the bearing steel composition by a powder metallurgical technique.

The process can be used to manufacture the bearing described herein.

The method employed in the present invention involves powder metallurgy. Powder metallurgy typically relies on a forming and fabrication technique comprising three major processing stages:

Powdering: the material to be handled is physically powdered and divided into many small individual particles.

Moulding: the powder is injected into a mould or passed through a die to produce a weakly cohesive structure close in dimension to the desired product.

Compression: the moulded article is subjected to compression and optionally high temperature to form the final article.

Each of the powder metallurgical steps is conventional in the art.

In a preferred embodiment of the process according to the present invention, the powder metallurgical technique comprises the steps of gas powder atomization of the bearing steel composition, followed by hot isotactic pressing. The gas powder atomization preferably uses an inert gas (for example, a gas comprising or consisting of nitrogen) in a closed system, so that contamination of the powder is reduced.

As noted above, the bearing component that is ultimately formed by the process may be a rolling element (for example ball or roller element), an inner ring, and an outer ring. The bearing component could also be part of a linear bearing such as ball and roller screws.

The composition used in the method preferably corresponds to the composition of the final article produced. However, while the weight percentage of most of the elements will remain essentially constant, the nitrogen content may decrease slightly, perhaps due to degassing. Also, any subsequent carburizing step will result in an increased carbon concentration in the surface region of the component.

In a further aspect the present invention provides the use of the steel alloy as described herein in a bearing component, in particular for increasing the lifetime of the bearing component at elevated operating temperatures and/or elevated operating loads.

### BRIEF SUMMARY OF THE DRAWINGS

The invention will now be described with reference to the following non-limiting figures, in which:

FIG. 1 shows a plot of HRC hardness values for a number of high speed steels after secondary hardening operations (from left to right: VIM-VAR M50, PM M50, PM M62, ASP 2060).

FIG. 2 shows a plot of rolling contact fatigue life factors at 400° C. for a number of high speed steels (from left to right: VIM-VAR M50, PM M50, PM M62, ASP 2060).

### DETAILED DESCRIPTION OF THE INVENTION

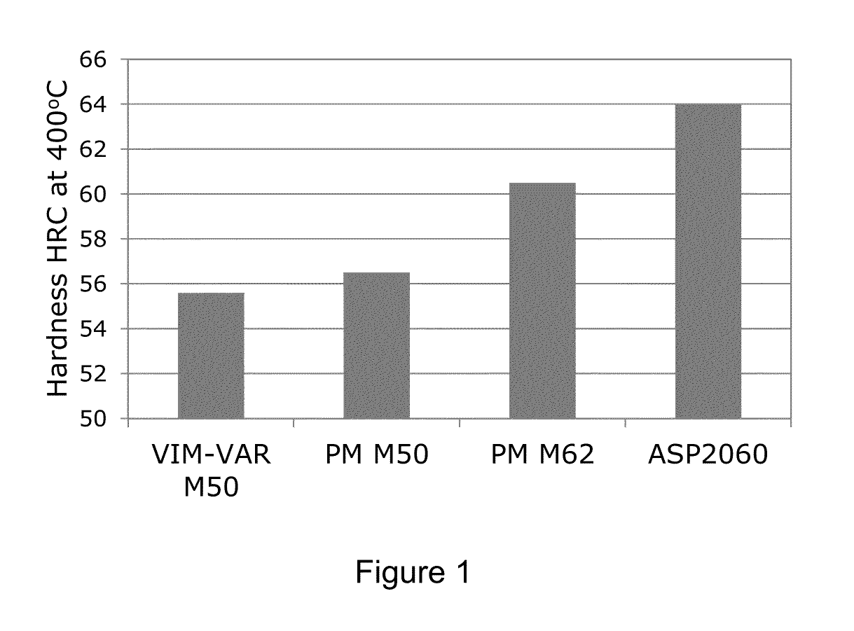

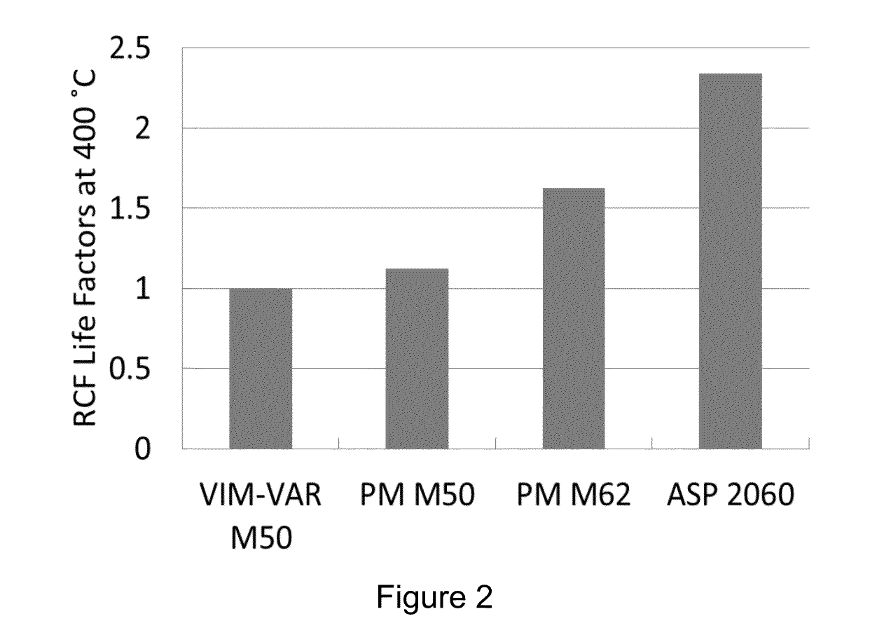

FIGS. 1 and 2 plot the mechanical properties of the alloys: (i) vacuum induction melted/vacuum arc refined M50, (ii) powder metallurgical M50, (iii) powder metallurgical M62 (1.3 wt. % C, 0.25 wt. % Si, 0.35 wt. % Mn, ≦0.030 P, ≦0.060 S, 3.75 wt. % Cr, 10.5 Mo, 2.0 V, 6.25 wt. % W, balance Fe) and (iv) ASP 2060 (2.30 wt. % C, 4.2 wt. % Cr, 7.0 wt. % Mo, 6.5 wt. % W, 6.5 wt. % V, 105 wt. % Co, balance Fe). As can be seen from the plots of FIGS. 1 and 2, the alloys used to form the bearing components of the present application, in particular PM M62 and ASP2060, exhibit high strength and high rolling contact fatigue life factors at elevated temperature. Accordingly, the performance of the bearing components of the present invention is improved in comparison to prior art bearing components.

1. A rolling element component of a bearing, the rolling element component being formed of a steel alloy comprising:
(a) from 0.8 to 2.5 wt. % C, p1 (b) from 3.5 to 4.5 wt. % Cr, p1 (c) from 3.9 to 11.25 wt. % Mo, p1 (d) from 6.3 to 6.7 wt. % V, p1 (e) at least one of the following elements:
from 0 to 8.2 wt. % W,
from 0 to 11 wt. % Co,
from 0 to 0.5 wt. % Ni,
from 0 to 0.35 wt. % Si,
from 0 to 0.4 wt. % Mn,
from 0 to 0.3 wt. % S,
from 0 to 0.05 wt. % P, and
(f) the balance iron, together with unavoidable impurities.

2. The rolling element component as recited in claim 1, wherein the steel comprises from 1 to 2.4 wt. % C.

3. The rolling element component as recited in claim 1, wherein the steel comprises from 3.6 to 4.3 wt. % Cr.

4. The rolling element component as recited in claim 1, wherein the steel comprises from 5 to 11 wt. % Mo.

5. The rolling element component as recited in claim 1, wherein the steel comprises from 5 to 7.5 wt. % W.

6. The rolling element component as recited in claim 1, wherein the steel comprises from 9 to 11 wt. % Co.

7. (canceled)

8. The rolling element component as recited in claim 1, wherein the steel comprises from 0.15 to 0.35 wt. % Si.

9. The rolling element component as recited in claim 1, wherein the steel comprises from 0.2 to 0.4 wt. % Mn.

10. The rolling element component as recited in claim 1, wherein the steel comprises from 2.2 to 2.4 wt. % C, from 3.8 to 4.2 wt. % Cr, from 6.8 to 7.2 wt. % Mo, from 6.3 to 6.7 wt. % W, from 6.3to 6.7 wt. % V and from 10.3 to 10.7 wt. % Co.

11. (canceled)

12. The rolling element component as recited in claim 1 formed by a powder metallurgical technique.

13. The rolling element component as recited in claim 1, wherein the steel has a strength of at least 65 HRC, preferably at least 68 HRC.

14. The rolling element component as recited in claim 1, wherein the steel has a rolling contact fatigue (RCF) factor at 400° C. of at least 1.5, preferably at least 2.

15. The rolling element component as recited in claim 1, wherein the steel has a hardness (HV5) at 400 ° C. of at least 700,preferably at least 750.

16. (canceled)

17. (canceled)

18. The rolling element component as recited in claim 17, wherein the rolling element component is integrated into a bearing.

19. The rolling element component as recited in claim 18, wherein the bearing is integrated into an aero engine.

20. A process for the manufacture of a rolling element component of a bearing, the process comprising:
(i) providing a bearing steel composition comprising:
(a) from 0.8 to 2.5 wt. % C,
(b) from 3.5 to 4.5 wt. % Cr,
(c) from 3.9 to 11.25 wt. % Mo,
(d) from 6.3 to 6.7 wt. % V,
(e) optionally one or more of the following elements
from 0 to 8.2 wt. % W,
from 0 to 11 wt. % Co,
from 0 to 0.5 wt. % Ni,
from 0 to 6.75 wt. % V,
from 0 to 0.35 wt. % Si,
from 0 to 0.4 wt. % Mn,
from 0 to 0.3 wt. % S,
from 0 to 0.05 wt. % P, and
(f) the balance iron, together with unavoidable impurities; and
(ii) forming the rolling element component from the bearing steel composition by a powder metallurgical technique.

21. The bearing component as recited in claim 1, wherein the steel comprises from 2 to 2.4 wt. % C.

22. The bearing component as recited in claim 1, wherein the steel comprises from 2.25 to 2.35 wt. % C.

23. The bearing component as recited in claim 1, wherein the steel comprises from 3.8 to 4.2 wt. % Cr.

24. The bearing component as recited in claim 1, wherein the steel comprises from 6 to 8 wt. % Mo.

25. The bearing component as recited in claim 1, wherein the steel comprises from 6 to 7 wt. % W.

26. The bearing component as recited in claim 1, wherein the steel comprises from 6.3 to 6.7 wt. % W.

27. The bearing component as recited in claim 1, wherein the steel comprises from 10.3 to 10.7 wt. % Co.

28. The bearing component as recited in claim 1, wherein the steel comprises from 0.2 to 0.3 wt. % Si.

29. The bearing component as recited in claim 1, wherein the steel comprises from 0.3 to 0.4 wt. % Mn.
